(19) United States
(12) Patent Application Publication
(10) Pub. No.: US 2026/0086837 A1
(43) Pub. Date: Mar. 26, 2026

(54) SOFTWARE DEPLOYMENT IN MULTI-TENANT ENVIRONMENTS

(71) Applicant: INTERNATIONAL BUSINESS MACHINES CORPORATION, Armonk, NY (US)

(72) Inventors: Zhi Li Guan, HaiDian District (CN); Jun Su, Beijing (CN); Peng Hui Jiang, Beijing (CN); Guang Han Sui, Beijing (CN)

(21) Appl. No.: 18/895,621

(22) Filed: Sep. 25, 2024

(51) Int. Cl. G06F 9/455; G06F 8/71

(52) U.S. Cl. CPC G06F 9/45558; G06F 8/71; G06F 2009/45562

(57) ABSTRACT

Computer-implemented methods, computer program products, and computer systems include program code continuously detecting software versions of custom resources and operators, where the software versions are associated with software provided as a service to the custom resources by an application programming interface (API) communicatively coupled to the operators. Based on the detecting, the program code determines, for each custom resource, whether an operator in the multiple tenant environment is providing a software version of the custom resource. Based on determining for a given custom resource of the custom resources that no operator in the multiple tenant environment is providing the software version of the given custom resource, the program code automatically deploys a new operator in a designated namespace, where the new operator provides the software version of the given custom resource to the given custom resource and the designated namespace is dedicated to the new operator.

### BACKGROUND

One or more aspects relate, in general, to facilitating processing within a computing environment, and in particular, to deploying software as a service (SaaS) to resources in multiple tenant computing environments.

A container image is a software package that includes the software to be used to run an application, including, for example, code, application and system libraries and runtime default settings. The size of container images continues to grow larger, and some are several gigabytes in size. A change, including a slight change, in configuration requires a different image, and at times, there are requirements to dynamically change the components in the image.

### SUMMARY

Shortcomings of the prior art are overcome, and additional advantages are provided through the provision of a computer-implemented method of facilitating operator management in a multiple tenant software as a service (SaaS) environment. The computer-implemented method includes continuously detecting, by one or more processors, software versions of custom resources and operators, where the software versions are associated with software provided as a service to the custom resources by an application programming interface (API) communicatively coupled to the operators. Based on the detecting, the method includes determining, by the one or more processors, for each custom resource, whether an operator in the multiple tenant environment is providing a software version of the custom resource. Based on determining for a given custom resource of the custom resources that no operator in the multiple tenant environment is providing the software version of the given custom resource, the method includes automatically deploying, by the one or more processors, a new operator in a designated namespace, wherein the new operator provides the software version of the given custom resource to the given custom resource and the designated namespace is dedicated to the new operator.

Shortcomings of the prior art are overcome, and additional advantages are provided through the provision of a computer program product for facilitating operator management in a multiple tenant software as a service (SaaS). The computer program product comprises a storage medium readable by one or more processors and storing instructions for execution by the one or more processors for performing a method. The method includes, for instance, continuously detecting, by the one or more processors, software versions of custom resources and operators, wherein the software versions are associated with software provided as a service to the custom resources by an application programming interface (API) communicatively coupled to the operators. Based on the detecting, the method includes determining, by the one or more processors, for each custom resource, whether an operator in the multiple tenant environment is providing a software version of the custom resource. Based on determining for a given custom resource of the custom resources that no operator in the multiple tenant environment is providing the software version of the given custom resource, the method includes automatically deploying, by the one or more processors, a new operator in a designated namespace, wherein the new operator provides the software version of the given custom resource to the given custom resource and the designated namespace is dedicated to the new operator.

Shortcomings of the prior art are overcome, and additional advantages are provided through the provision of a computer system for facilitating operator management in a multiple tenant software as a service (SaaS). The system includes: a memory, one or more processors in communication with the memory, and program instructions executable by the one or more processors via the memory to perform a method. The method includes continuously detecting, by the one or more processors, software versions of custom resources and operators, wherein the software versions are associated with software provided as a service to the custom resources by an application programming interface (API) communicatively coupled to the operators. Based on the detecting, the method includes determining, by the one or more processors, for each custom resource, whether an operator in the multiple tenant environment is providing a software version of the custom resource. Based on determining for a given custom resource of the custom resources that no operator in the multiple tenant environment is providing the software version of the given custom resource, the method includes automatically deploying, by the one or more processors, a new operator in a designated namespace, wherein the new operator provides the software version of the given custom resource to the given custom resource and the designated namespace is dedicated to the new operator.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present invention;

FIG. 2 depicts one example of a node, in accordance with one or more aspects of the present invention;

FIG. 3 illustrates an operator in a platform in a multi-tenant environment that provides software as a service (SaaS);

FIGS. 4A and 4B illustrate various aspects of a SaaS environment with multiple tenants;

FIG. 5, which includes FIG. 5A and FIG. 5B, is a workflow that illustrates various aspects of the present disclosure;

FIG. 6 depicts one example of a technical environment in which various aspects of the examples herein have been implemented in order to practice the workflow of FIG. 5;

FIG. 7 illustrates certain aspects of designator utilized in the examples herein to enable detection of version numbers of software utilized by custom resources in various namespaces in the technical environments described herein;

FIG. 8 illustrates certain aspects an operator manager in accordance with certain aspects of the present disclosure; and

FIG. 9 illustrates the generation and deployment of an operator by an operator manager in some examples herein in accordance with certain aspects of the present disclosure.

### DETAILED DESCRIPTION

In accordance with one or more aspects, a capability is provided to facilitate operator management in multiple tenant SaaS environments. The operator management described herein serves to facilitate processing within a computing environment. In one or more aspects, the capability includes improving deployment of software (e.g., software as a service or SaaS) provided in container images within the computing environment. The examples herein provide a method of platform operator management in a multiple tenant SaaS environment. A non-limiting example of a platform that can be enhanced through the utilization of the examples described herein is Kubernetes®, which is an open-source, extensible, portable container management platform. Kubernetes is a registered trademark of The Linux Foundation, San Francisco, CA.

Other platforms may also be used. In Kubernetes, for example, a container has its own central processing unit share, filesystem, process space, memory and more. Further, containers may share the operating system (OS) among applications due to their relaxed isolation properties; containers are decoupled from the underlying infrastructure; containers are portable across operating system distributions and clouds; and each container is repeatable. Containers are intended to be stateless and immutable—code of a running container is not to be changed; instead, a new container image is built to include the change.

Containers in Kubernetes, as well as containers in other platforms, can be isolated from each other as well as from the underlying infrastructure, into separate namespaces that are managed by individual operators. Each namespace can be occupied by a given tenant. In existing multi-tenant environments that utilize platforms such as Kubernetes, only one operator can be installed in each tenant namespace, which can be cost prohibitive in some computing environments. The use of individual operators in each pod in shared computing environment can strain CPU and memory resources and additionally, volume cost for this type of configuration is high as operators continuously reconcile and generate output. Existing platform configurations do not allow for the installation of two operators on different versions (of a software it is administering) in one namespace, meaning that resources in a given namespace would be standardized on a common software version, which is not always possible, in operation, based on issues including but not limited to resource limitations and customer requirements.

In computing environments, custom objects, which can be referred to as operators, can execute on pods in resource clusters and interface with application programming interface (API) servers to access containers, which the operators can deploy to resources comprising the pods. Each tenant in a multi-tenant environment (e.g., cloud computing environment) can have its own namespace and this namespace will be controlled by a single operator. Namespace-level tenancy is a configuration that isolates tenants on the same cluster using namespaces. However, a multi-tenant SaaS application is a type of software architecture that allows multiple users or tenants to access and use the same instance of an application simultaneously. The usage of individual operators for each namespace works against the advantages of the SaaS deployment. While multi-tenant software architecture, which enables multiple users to share a single instance of a software application and its underlying resources, is the foundation of most SaaS offerings, shared computing environments that utilize separate operators for each namespace (gaining isolation advantages) cannot utilize this resource-sharing advantage.

In existing environments that utilize a platform architecture with operators who perform as a gateway between cluster resources and application programming interfaces (APIs) (to provide SaaS), the limitation of one operator per version per namespace can compromise resource efficiency and system optimization. In computing environments, because different tenants can desire to utilize different versions of SaaS, it can become expensive and inefficient, from a processing standpoint, to maintain all the tenants on the same version, in part because different users in a common namespace could have different requirements. Additionally, upgrading all tenants in a namespace at one time can be complex and technically challenging as the upgrade must account for the needs of all users and these needs can vary. Meanwhile, as aforementioned, installing and utilizing an operator in each tenant namespace can be cost prohibitive, from a CPU and memory standpoint, and can compromise processing efficiency. The volume cost is large as operators would continuously reconcile and generate output.

In existing environments that utilize a platform architecture with operators who perform as a gateway between cluster resources and application programming interfaces (APIs) (to provide SaaS), the limitation of one operator per version per namespace can compromise resource efficiency and system optimization. In computing environments, because different tenants can desire to utilize different versions of SaaS, it can become expensive and inefficient, from a processing standpoint, to maintain all the tenants on the same version, in part because different users in a common namespace could have different requirements. Additionally, upgrading all tenants in a namespace at one time can be complex and technically challenging as the upgrade must account for the needs of all users and these needs can vary. Meanwhile, as aforementioned, installing and utilizing an operator in each tenant namespace can be cost prohibitive, from a CPU and memory standpoint, and can compromise processing efficiency. The volume cost is large as operators would continuously reconcile and generate output.

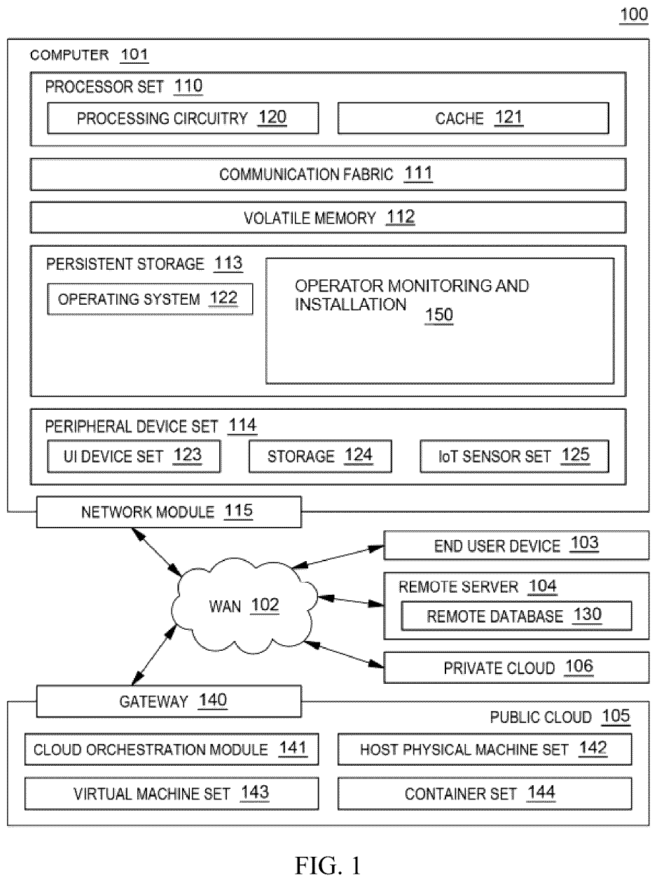

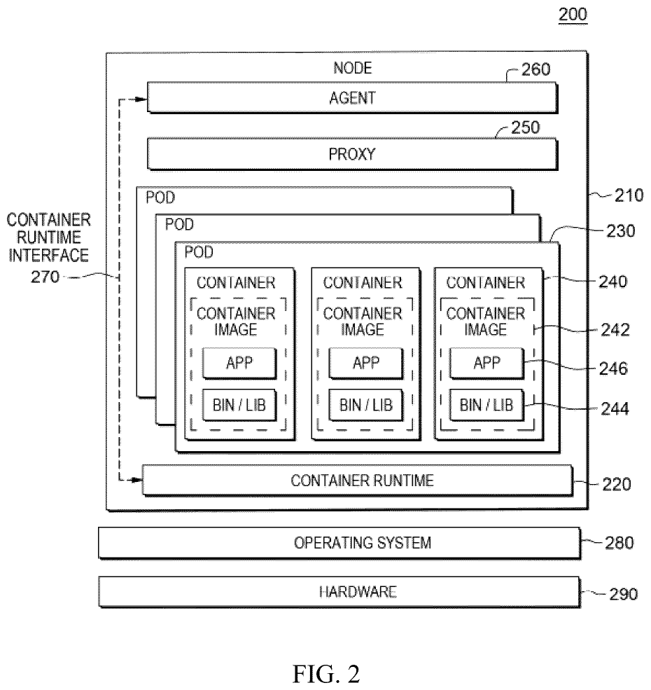

Computing environments, including computing environment 100 example illustrated in FIG. 1 support containers utilized in Kubernetes and in other computing platforms. The containers may be provided in a cloud, such as a public cloud (e.g., public cloud 105), a private cloud [symbol] e.g., private cloud 106), a hybrid cloud and/or on-premises (e.g., computer 101). In one example, containers are managed by one or more of various management platforms. One example of such a platform is Kubernetes but other platforms may also be used. Further details regarding architectures that include platforms and containers are described with reference to FIG. 2. Both FIGS. 1 and 2 are described in greater detail herein.

The computer-implemented methods, computer program products, and computing systems described herein facilitate operator management in a multiple tenant SaaS environment. These computer-implemented methods, computer program products, and computing systems are inextricably tied to computing and directed to a practical purpose at least because they improve processing and software utilization within muti-tenant computing environments and are directed to the practical application of providing tenants with different software versions in a flexible and efficient manner. As will be explained in greater detail herein, program code executing on one or more processors can launch an operator for each version of a software in a dedicated namespace. The program code can configure this operator to run in all-namespace mode, so it can monitor all the deployed custom resources (CRs) in all the platform (e.g., Kubernetes) namespaces. Thus, the program code can install operator on demand intelligently. Among the practical applications of this approach (which is inextricably tied to computing as it addresses efficiency and software versioning issues in a multi-tenant computing environment) are a reduction in resource cost, a reduction in administrative workload, and an improved user experience, based on eliminating a need to install a new operator in an upgrade scenario. Instead, the program code comprising an operator manager can detect a CR version and install an operator automatically. Providing SaaS to resources in a computing environment and managing upgrades utilizing changes to a computing infrastructure, which in this case can include, adding new elements to CR definitions and implementing changes to deployment of operators and the configuration of the operators as well as the CRs, represent actions that are inextricably tied to computing. These actions are implemented to address known processing inefficiencies in existing environments, and hence, are directed to a practical application.

The computer-implemented methods, computer program products, and computing systems described herein provide significantly more than existing multi-tenant platform management systems. For example, as described herein, various aspects enable the installation of an operator on demand and intelligently. The installation and configuration described herein reduces resource costs and administrator workload. As will be described in greater detail herein, the on-demand configuration is enabled by implementing a method of operator management in multiple tenant SaaS environments that includes adding a flag in a Custom Resource Definition (CRD) indicating which version the custom resource (CR) is utilizing. In these examples, an operator manager running in an all-namespace mode manages the operators running on different versions. Program code executing on one or more processors monitors the installed CRs deployed in all namespaces of the platform (e.g., Kubernetes). Program code can detect specific versions of each installed CR according to the pre-defined flag in the CRD. Detecting a flag (and hence a version) can trigger program code to install a version, for each versioned operator, based on a predefined operator version and catalog source mapping relationship. The program code can launch an operator for each of the specific versions in a dedicated namespace. The program code can configure this operator to run in all-namespace mode, so it can monitor all the deployed CRs in all the platform namespaces. Thus, managing the environment can include enabling program code to maintain relationships of operator versions and namespaces in a configuration map (configmap). To streamline processing and operations in the SaaS environment, program code executing in the environment can destroy or otherwise terminate specific versions of operators if there are no CRs associated with this operator.

The examples herein include computer-implemented methods, computer program products, and computer systems for facilitating operator management in a multiple tenant environment. In some of these examples, program code executed by one or more processors continuously detects, by one or more processors, software versions of custom resources and operators, wherein the software versions are associated with software provided as a service to the custom resources by an application programming interface (API) communicatively coupled to the operators. Based on the detecting, the program code determines, for each custom resource, whether an operator in the multiple tenant environment is providing a software version of the custom resource. Based on determining for a given custom resource of the custom resources that no operator in the multiple tenant environment is providing the software version of the given custom resource, the program code automatically deploys a new operator in a designated namespace, where the new operator provides the software version of the given custom resource to the given custom resource and the designated namespace is dedicated to the new operator.

In some examples, based on the program code detecting, the program code determines, for each operator, whether at least one custom resource of the custom resources is utilizing a software version of the operator. Based on determining for a given operator that no custom resource operator in the multiple tenant environment is utilizing the software version provided by the given operator, the program code disposes of the given operator.

In some examples, based on the automatically deploying, the program code updates a configuration map to map the given custom resource to the new operator.

In some examples, based on disposing of the given operator, the program code updates a configuration map to eliminate references to the given operator.

In some examples, the program code continuously detecting comprises the program code utilizing a definition file to interpret a special flag in each custom resource to determine a version for each custom resource of the custom resources.

In some examples, the program code implements a field in the API. Based on the program code implementing, the API adds the field to the definition file, which implements the field and a value for the field in each custom resource of the custom resources. The value for the field comprises the special flag.

In some examples, the program code continuously detecting is performed by an operator manager operating in an all-namespace mode.

In some examples, the program code automatically deploying comprises the program code deploying the new operator to function in an all-namespace mode.

In some examples, the program code automatically deploying comprises the program code obtaining, from a catalog source, artifacts associated with the software version of the given custom resource. The program code utilizes the artifacts to deploy the new operator.

In some examples, the operators comprise Kubernetes operators.

One or more aspects of the present invention are incorporated in, performed and/or used by a computing environment. The computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) to, e.g., deploy container images and/or perform one or more other aspects of the present invention. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 1. In one example, computing environment 100 contains an example of an environment for the execution of at least some of the computer code involved in performing the inventive methods, such as an operator monitoring and installation module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

In one example, the computing environment 100 supports containers. The containers may be provided in a cloud, such as a public cloud (e.g., public cloud 105), a private cloud (e.g., private cloud 106), a hybrid cloud and/or on-premises (e.g., computer 101). In one example, containers are managed by one or more of various management platforms, such as Kubernetes, for example, in which a container has its own central processing unit share, filesystem, process space, memory and more. These containers may share the operating system (OS) among applications due to their relaxed isolation properties; containers are decoupled from the underlying infrastructure; containers are portable across operating system distributions and clouds; and each container is repeatable. Containers are intended to be stateless and immutable—code of a running container is not to be changed; instead, a new container image is built to include the change. Further details regarding containers are described with reference to FIG. 2.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

As indicated earlier, in at least one example, computing environment 100 supports containers. The containers may be provided in a cloud, such as a public cloud (e.g., public cloud 105), a private cloud (e.g., private cloud 106), a hybrid cloud and/or on-premises (e.g., computer 101). In one example, containers are managed by one or more of various management platforms and one example of such a platform is Kubernetes. Further details regarding containers are described with reference to FIG. 2.

In one example, referring to FIG. 2, a computing environment 200 includes one or more nodes 210, an operating system 280 shared by the one or more nodes, and underlying hardware 290, such as processing units, etc. used by the one or more nodes. The nodes may be virtual or physical machines, and they may be on-premise (e.g., in computer 101 and/or other computing devices) and/or in a cloud environment (e.g., public cloud 105, private cloud 106, a hybrid cloud environment and/or other cloud environment). In one example, computing environment 200 employs a platform, such as Kubernetes and/or another platform, to manage the containers. Kubernetes is a platform for running and managing containers from a plurality of container runtimes, including, but not limited to, Docker®, containerd®, Container Runtime Interface-Open Container Initiative (CRI-O), etc. Although examples of platforms and runtimes are provided, additional, fewer and/or other platforms and/or runtimes may be used. Docker is a registered trademark of Docker, Inc., San Francisco, CA; and containerd is a registered trademark of The Linux Foundation, San Francisco, CA.

In one example, a node 210 includes a container runtime 220, such as, for instance, Docker, containerd, Container Runtime Interface-Open Container Initiative (CRI-O), etc.; one or more pods 230; a proxy 250; and an agent 260. One example of proxy 250 is a kube-proxy, which is a network proxy that runs on each node in a cluster, implementing part of the Kubernetes Service concept. A kube-proxy maintains network rules on the nodes, and these network rules allow network communication to the pods from network sessions inside or outside of the cluster. One example of agent 260 is a kubelet that runs on each node. It can register the node, using one or more of a hostname, flag or other, with an application programming interface (API) server that validates and configures data for objects (e.g., pods). In other examples in which the platform is other than Kubernetes, the proxy and agent may be for that platform. Many examples are possible.

In one example, a container runtime interface 270 is provided, which is a plugin interface that enables agent 260 (e.g., the kubelet) to use a wide variety of container runtimes (e.g., container runtime 220) without having to recompile the cluster components.

In one example, a pod 230 includes one or more containers 240, and a container 240 includes, for instance, a container image 242 having one or more applications 246 with one or more libraries 244, and/or one or more binary and/or text resources. A container image is deployed on the node (e.g., node 210), as described herein.

In accordance with one or more aspects, deployment of a container image (e.g., container image 242) is facilitated, reducing and stabilizing the size of the image. In one or more aspects, a container image deployment module is used to deploy container images, at runtime. A container image deployment module includes code or instructions used to perform container image deployment, in accordance with one or more aspects of the present invention. A container image deployment module includes, in one example, various sub-modules to be used to perform the processing. The sub-modules are, e.g., computer readable program code (e.g., instructions) in computer readable media, e.g., storage (storage 124, persistent storage 113, cache 121, other storage, as examples). The computer readable media may be part of a computer program product and the computer readable program code may be executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computers, servers, processors, nodes, processing circuitry and/or other computing devices may be used to execute one or more of the sub-modules and/or portions thereof. Many examples are possible.

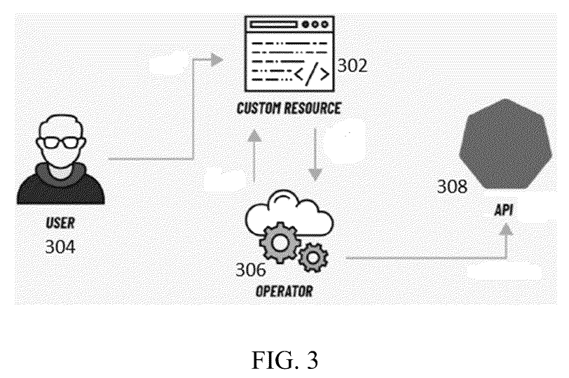

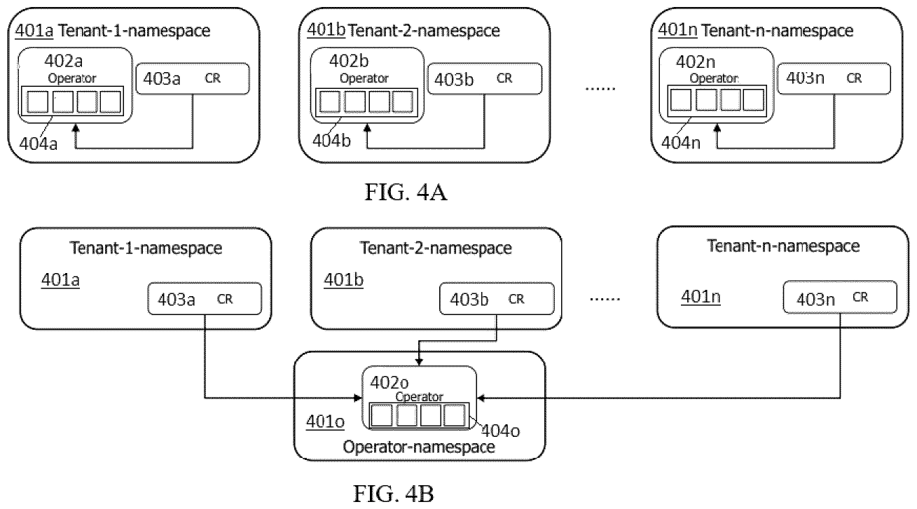

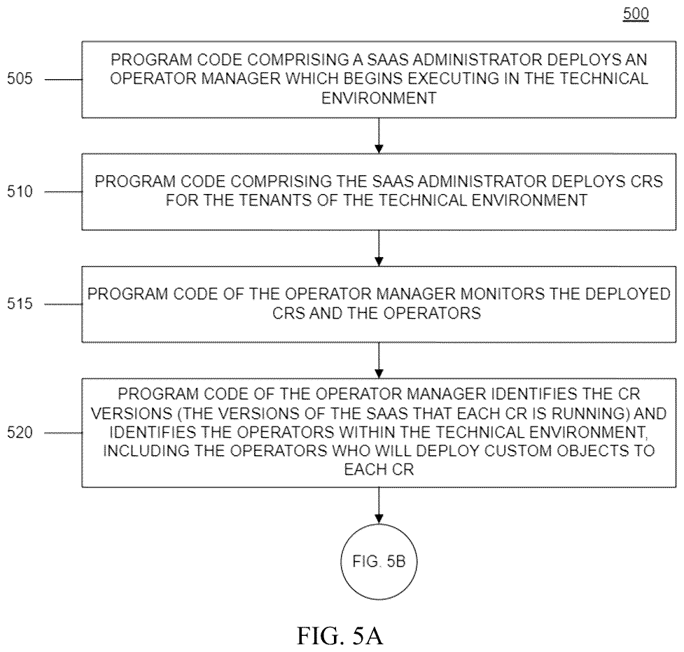

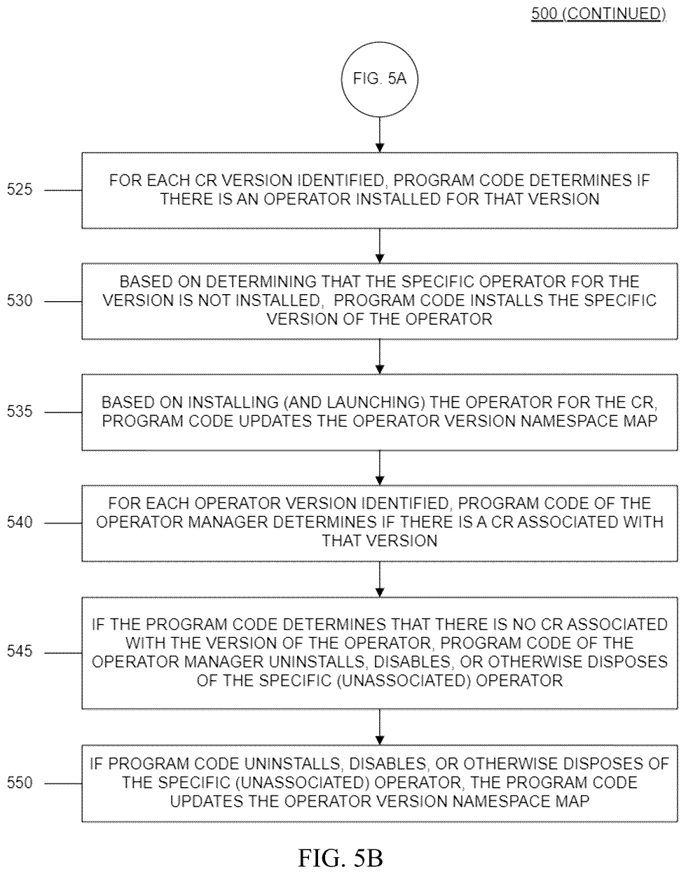

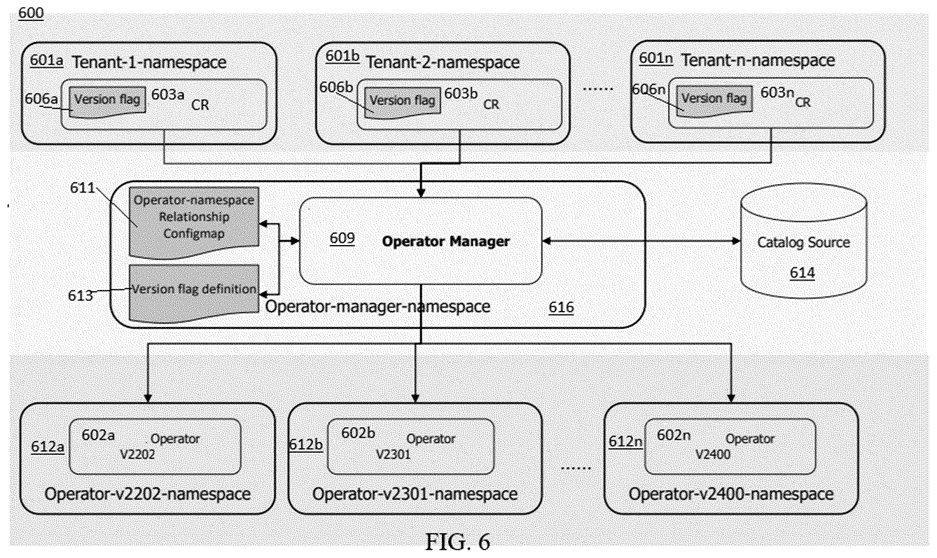

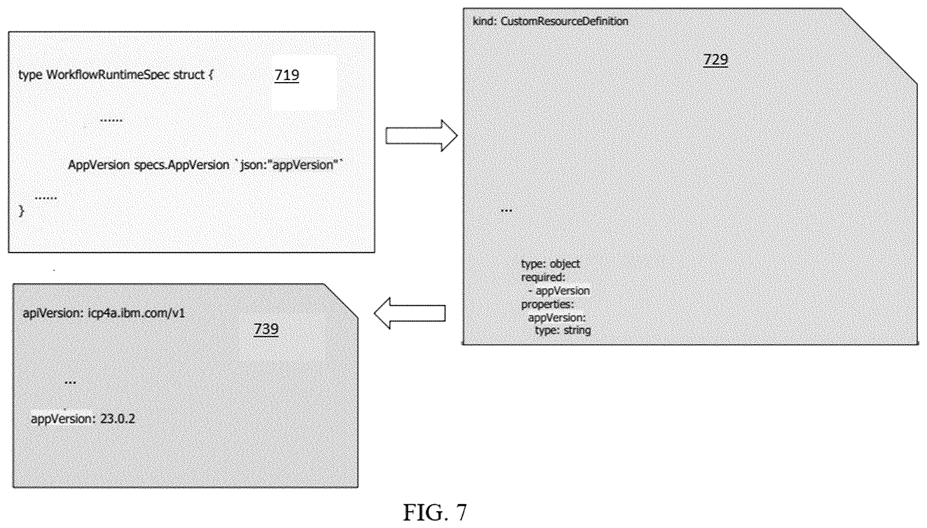

The remaining figures illustrates computing environments that utilize operators, including current approaches, as well as the approaches described herein to improve processing and efficiency within these environments. FIG. 3 illustrates an operator in a platform in a multi-tenant environment that provides SaaS; operators are deployed in both existing configurations and the configurations described herein. FIGS. 4A and 4B illustrate various aspects of a SaaS environment with multiple tenants, including challenges addressed when environments are configured using existing approaches. FIG. 5, which includes FIG. 5A and FIG. 5B, is a workflow that illustrates aspects introduced herein to address the challenges illustrated in the prior figures and to enable improvements to the processing environment. FIG. 6 depicts one example of a technical environment in which various aspects of the examples herein have been implemented to practice the workflow of FIG. 5. Meanwhile, FIGS. 7-9 provide additional details regarding the workflow introduced in FIG. 5 and the impacts within the technical environment illustrated in FIG. 6.

As noted above, FIG. 3 illustrates an operator 306 in a platform in a multi-tenant environment that employs SaaS. FIG. 3 illustrates a CR 302 in a multi-tenant environment that is accessed by a user 304 and managed by an operator 306, which connects to the platform's API server 308 (e.g., Kubernetes API server). The operator 306 is comprised of program code executed by one or more processors that is running in a pod on a cluster, interacting with the (e.g., Kubernetes) API server 308. A non-limiting example of muti-tenant (e.g., cloud computing) environment into which operators can be utilized as illustrated in FIG. 3 is IBM Cloud Pak for Business Automation (IBM CP4BA) as a service. IBM Cloud Pak for Business Automation as a service (IBM CP4BA service) is a modular set of integrated software components, built and designed to automate work and accelerate business growth. The program code comprising the operator 306 can introduce new object types through CRDs, which is an extension mechanism for various platforms, including in Kubernetes. The custom objects provided by the operator 306, which are accessible via the CR 302, are a primary interface for a user 304 to the CR 302. The software of the SaaS is embodied in this custom object provided to the user 304 and deployed using the operator 306. A user 304 can access the software deployed by the operator 306 and modify the CR 302. The operator 306 monitors the CR 302 and obtains, via the CR 302, any change events. The operator 306 can adjust the state of the API server 308 based on the change events obtained via the CR 302.

FIGS. 4A and 4B illustrate a SaaS environment with multiple tenants. A multi-tenant SaaS application is a type of software architecture that allows multiple users or tenants to access and use the same instance of an application simultaneously. Multiple tenant (or multi-tenant) architectures ideally enable multiple users to share a single instance of a software application and its underlying resources; this is a foundation of most SaaS offerings. Tenants can be isolated into different spaces to designate which resources can share software (e.g., custom objects). In some examples, application logic can define multi-tenancy configurations. FIGS. 4A and 4B utilize name-space level tenancy and isolate tenants on the same cluster using namespaces. Cluster-level tenancy is also a means of isolating different resources such that resources that utilize a common version can share this version. As aforementioned, in existing configurations, the usage of operators in muti-tenant environments to enable resources to access SaaS can provide various challenges.

FIGS. 4A and 4B illustrate an existing configuration where tenants (each with a dedicated namespace) can only share an operator if the tenants in each namespace are all on the safe version of the software (provided by the operator via the SaaS server) because one cannot install two operators on different versions in one namespace using this existing approach. As aforementioned, the configuration of this environment is costly and can be inefficient. It is difficult (and sometimes not possible because of differing user resource requirements) to maintain all the tenants on the same version. Upgrades are also complex because all tenants must be upgraded within the same time frame which can create administrative bottlenecks.

Because of the requirement for conformity in this configuration, even if a user has requirements for specified version, the requirements sometimes cannot be met. Although technically an operator can be installed in each tenant namespace, this configuration is cost prohibitive (from a processing and resource cost point of view (e.g., CPU and memory resources)). The volume cost of this configuration is also large because the operator continuously reconciles and keeps generating output.

Referring to FIG. 4A, in this example, in each namespace 401a-401n, a distinct operator 402a-402n is deployed. The operators 402a-402n individually provide objects to the CRs 403a-403n in each namespace 401a-401n. Each operator 402a-402n can comprise various components 404a-404n but as a non-limiting example, in some configurations, the objects operators 402a-402n can comprise, but are not limited to, include command prefix strings (CPFs), business automation workflow (BAW), and enterprise content management (ECM).

Referring to FIG. 4B. because each tenant (in each namespace 401a-401n ) comprises CRs 403a-403n that are running the same version of software, a common operator 402o with common components 404o can provide the objects to the CRs 403a-403n in each namespace 401a-401n. The operator 404o resides in its own (operator) namespace 404o. However, as aforementioned, achieving this type of version conformity can be challenging and sometimes not possible.

FIG. 5, which is comprised of FIGS. 5A and 5B, separated for clarity, is a workflow 500 that illustrates an approach for utilizing operators to deploy software in a multi-tenant to enable sharing of software resources between tenants, more efficiently and effectively than in existing approaches. While FIG. 5 illustrates a workflow 500, while FIG. 6 illustrates a technical architecture in which the workflow 500 can be implemented. For ease of understanding, the workflow is described initially 500 and when the technical architecture 600 is reviewed, references to the workflow 500 are provided in this discussion. As will be discussed in greater detail herein, the examples described below include at least three elements that enable more effective and efficient management of processing resources (and hence optimize processing in general), in a multi-tenant SaaS environment. The elements are: 1) an operator manager, which is deployed to manage operators across all namespaces; 2) a flag, which is added in a CRD of each CR to indicate which version (of software) the CR is providing (to the user); and 3) a centralized mapping of operators to CRs for all namespaces, which is maintained.

In the examples herein, program code comprising an operator manager is deployed into the technical environment. This operator manager runs in an all-namespace mode and manages the operators, which are running on different versions. Because the operator manager is configured to run in all-namespace mode, it can monitor all the deployed CRs in all the (e.g., Kubernetes) namespaces. When an operator manager (or an operator) is initialized with no namespace option specified, or a namespace of “ ”, it will monitor (e.g., communicate) with resources in all namespaces. Thus, in certain examples herein although the operator manager (as well as the operators themselves) are launched in specific namespaces (for the operators they are version-exclusive namespaces), the operators and the operator manager, because they operate in all-name space mode, can monitor all platform (e.g., Kubernetes) namespaces.

In the examples herein, the program code comprising the operator manager controls the generation, deployment, and destruction (expiration) of operators. Each operator is tied to a given version of software in the technical architecture. The technical architecture is a multi-tenant environment in which software is deployed as a service (e.g., SaaS). As aforementioned, operators are communicatively coupled to an API server from which the operators obtain custom objects for deployment to CRs in the namespaces of the multi-tenant environment. Thus, as illustrated in FIG. 5, in this workflow 500, program code comprising a SaaS administrator deploys an operator manager which begins executing in the technical environment (505). Program code comprising the SaaS administrator deploys CRs for the tenants of the technical environment (510). Once the CRs and the operator manager have been deployed and are executing within the technical environment, the program code of the operator manager can monitor the deployed CRs and the operators (515). The program code monitors all installed CRs deployed in all platform (e.g., Kubernetes) namespaces.

As part of monitoring the CRs, the program code of the operator manager identifies the CR versions (the versions of the SaaS that each CR is running) and identifies the operators within the technical environment, including the operators who will deploy custom objects to each CR (520). To identify the CR versions of the CRs, the program code of the operator manager can reference a version flag, which is an attribute of the CR and can be defined by a file in an operator manager namespace. The operator manager can utilize the definition to identify the operator version. In addition to the definition, the program code of the operator manager can also access an operator version namespace map (e.g., configmap), also in an operator manager namespace. By maintaining (continuously updating) the configmap, the program code keeps a current record of relationships between operator version and namespaces. The version flag can be understood as a special flag in a CRD of a CR. The version flag indicates which version the CR is providing to and end user. Hence, in some examples, the program code detects the specific version of each installed CR according to the pre-defined flag in a CRD.

The program code of the operator manager evaluates the version numbers of both the CRs and the operators to determine (and address) whether there is an operator for each CR version and whether there is a CR associated with each operator version. Although the workflow 500 arguably suggests that these evaluations and subsequent actions are performed by the program code of the operator manager in a particular order, these processes can be performed synchronously, asynchronously, consecutively, etc. In some examples, the program code evaluates and addresses version numbers of the of the CRs and the operators as a background process, such as by executing a backend daemon. As part of the monitoring, the operator manager continuously checks and updates (in a namespace map), the versions of the operators and checks to make sure that each operator executing has CRs (that are utilizing the version of the operator).

As noted above, for each CR version, the program code of the operator manager identified, the program code determines if there is an operator installed for that version (525). Based on determining that the specific operator for the version is not installed, the program code installs the specific version of the operator (530). In installing this version, the program code can access an operator catalog as the source of the components or objects needed to facilitate generating and deploying an operator for this specific version. The program code installing an operator can be triggered for each versioned operator based on a predefined operator version and catalog source mapping relationship. The program code of the operator manager launches operators for each specific version in a dedicated namespace. Based on installing (and launching) the operator for the CR, the program code updates the operator version namespace map (in the operator manager namespace) (535).

For each operator version the program code identifies, the program code of the operator manager determines if there is a CR associated with that version (540). If the program code determines that there is no CR associated with the version of the operator, the program code of the operator manager uninstalls, disables, or otherwise disposes of the specific (unassociated) operator (545). Should the program code uninstall, disable, or otherwise dispose of the specific (unassociated) operator, the program code updates the operator version namespace map (e.g., in the operator manager namespace) (550).

Thus, as illustrated in FIG. 5, when a CR version does not have a corresponding operator to handle it, program code comprising the operator manager installs an operator for this missing version. Conversely, if an operator does not have a CR associated with it, the operator manager will uninstall (or otherwise dispose of) that operator. When the program code comprising the operator manager launches a new operator (for a given version), the program code launches that operator (and each operator) in a dedicated namespace. However, the program code configures the operator to run in all-namespace mode, so it can monitor all the deployed CRs in all the namespaces.

FIG. 6 illustrates aspects of a computing environment 600 into which aspects of the examples herein have been implemented. As illustrated in FIG. 6, each tenant namespace 601a-601n includes a CR 603a-603n (there can be more than one CR in a namespace and this example is provided for illustrative purposes). As discussed in FIG. 5, each CR, in its CRD, includes a version flag 606a-606n which indicates the software version (e.g., software is provided as SaaS) of the CR. The operator manager 609 monitors the CRs 603a-603n in all namespaces 601a-606n (because the operator manager operates in an all-namespace mode), and can utilize the version flag definition 613 (which can be in the operator manager namespace 616) to detect the versions of the CRs 603a-603n when monitoring these CRs 603a-603n.

The operator manager 609 also monitors operators 602a-602n deployed in the technical environment 600. In this example, each operator 602a-602n was deployed into its own (operator) namespace 612a-612n but can be deployed to operate in an all-namespaces mode such that the operators can monitor or otherwise interact with (e.g., provide customs objects to) CRs 601a-601n in various tenant namespaces 603a-603n.

The operator manager 609 continuously detects the versions of both the CRs 601a-601n and of the operators 602a-602n. The program code determines whether there is an operator for each CR version and whether there is a CR associated with each operator version. For each CR 601a-601n, the program code of the operator manager 609 detects a version, and for each version based on the version flag 606a-606n (utilizing the version flag definition 613), detected, the program code of the operator manager 609 determines if there is an operator installed for that version (e.g., FIGS. 500, 525). The program code can reference the operator-namespace relationship manager 611 to determine that the specific operator for a given version is not installed. When there is no operator 602a-602n for a given version, the program code installs the specific version of the operator (e.g., FIGS. 5, 530). To install this version, the program code can access catalog source 614 for components or objects needed to facilitate generating and deploying an operator for this specific version. Thus, this installation is triggered for each versioned operator based on a predefined operator version and catalog source 614 mapping relationship. The program code of the operator manager launches operators for each specific version in a dedicated namespace 612a-612n. Based on installing (and launching) an operator for a CR of a specific version, the program code updates the operator version namespace map 611 (in the operator manager namespace 616) (e.g., FIGS. 5, 535).

For each operator version the program code identifies, the program code of the operator manager 609 references the operator-namespace relationship configuration 611 (a configuration map) to determine if there is a CR 601a-601n associated with that version (e.g., FIGS. 5, 540). FIG. 6 depicts, for illustrative purposes only and not to suggest any limitations, dedicated operator namespaces 612a-612n for versions 2202, 2301, and 2400 for SaaS provided to the CRs by these operators. As illustrated in FIG. 5, if there is no CR associated with the version of the operator, the program code of the operator manager uninstalls, disables, or otherwise disposes of the specific (unassociated) operator (e.g., FIGS. 5, 545). The program code updates the operator version namespace map 611 (e.g., in the operator manager namespace) with any changes to mappings between CRs and operators.

In some examples herein, the flag 606a-606n in the CRD indicating which version the CR 601a-601n is utilizing can be based on a new field being added in the API (for the SaaS) and provided to the CRD, which provides it to the CR. FIG. 7 illustrates the special flag in CRD indicating which version a CR is executing of a software (provided by an operator communicatively coupled to an API). Referring to FIG. 7, the new field is referred to as “appVersion” (indicating application version). The field can be added (e.g., via Golang) to an API 719. The API 719 populates this field in the CRD 729, which populates the field in the CR 739. As illustrated in FIG. 7, the application version (appVersion) of the CR 739, according to the flag, is 23.0.2.

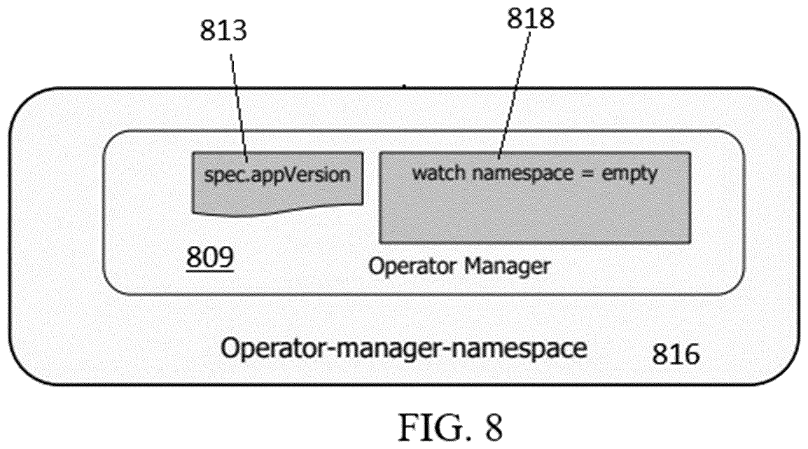

As illustrated in FIGS. 5-6, an operator manager 609 monitors and retrieves deployed CR version numbers across platform namespaces. FIG. 8 illustrates an operator manager 809 in an operator namespace 816. The operator manager 809 obtains version information from CRs executing in all namespaces. To access the CRs across namespaces, the operator manager 609 is set to all-namespaces (e.g., watch namespace=empty 818). Because the namespace value is empty, the default is all namespaces. Additionally, so that the operator manager 609 can detect version numbers and locates special flags in the CRs, the operator manager 609 includes a specification that defines the flag, in this case, “appVersion”, as illustrated in FIG. 7. The special flag definition (e.g., FIGS. 6, 613) in FIG. 8 is a more specific spec. appVersion 813, a specification or definition for a value that is used as a non-limiting example to represent the version of a CR (e.g., in a CRD). The operator manager 609 detects distinct CR versions.

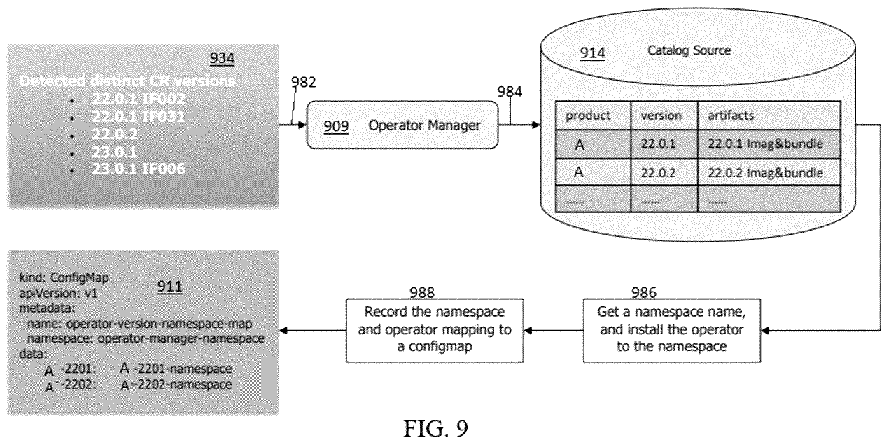

As illustrated in FIG. 5, an installation of an operator can be triggered for each versioned operator based on a predefined operator version and catalog source mapping relationship and based on installing (and launching) the operator for the CR, the program code updates the operator version namespace map (in the operator manager namespace) (535). FIG. 9 illustrates the triggered installation for each versioned operator based on a predefined operator version and catalog source mapping relationship in greater detail.

As illustrated in FIG. 9, program code comprising the operator manager 909 has detected distinct CR versions 934 (provided to the operator manager 909) and hence, obtains the CR versions 934 (982). The program code of the operator manager 909 then obtains components (e.g., artifacts) for the product (e.g., A) for the version of the product utilized by the CR from catalog source 914 (984). The catalog source 914, in this example, includes mappings from the product to the version, and to the relevant artifacts for that version. The program code of the operator manager 909 installs and deploys an operator into a dedicated namespace for that version of the product, which includes obtaining a namespace name and installing the operator to the namespace (986). The program code records the namespace to operator mapping in the configuration map. As discussed above, in these examples, if the program code identifies an operator with a version with which no CRs are associated, the program code uninstalls or otherwise halts operation of this operator.

Although various embodiments are described above, these are only examples. For example, different types of platforms, protocols, interfaces, add-ons, etc. may use and/or benefit from one or more aspects of the present invention. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating operator management in a multiple tenant environment, the computer-implemented method comprising:
continuously detecting, by one or more processors, software versions of custom resources and operators, wherein the software versions are associated with software provided as a service to the custom resources by an application programming interface (API) communicatively coupled to the operators;
based on the detecting, determining, by the one or more processors, for each custom resource, whether an operator in the multiple tenant environment is providing a software version of the custom resource; and
based on determining for a given custom resource of the custom resources that no operator in the multiple tenant environment is providing the software version of the given custom resource, automatically deploying, by the one or more processors, a new operator in a designated namespace, wherein the new operator provides the software version of the given custom resource to the given custom resource and the designated namespace is dedicated to the new operator.

2. The computer-implemented of claim 1, further comprising:
based on the detecting, determining, by the one or more processors, for each operator, whether at least one custom resource of the custom resources is utilizing a software version of the operator; and
based on determining for a given operator that no custom resource operator in the multiple tenant environment is utilizing the software version provided by the given operator, disposing of the given operator.

3. The computer-implemented of claim 1, further comprising:
based on the automatically deploying, updating, by the one or more processors, a configuration map to map the given custom resource to the new operator.

4. The computer-implemented of claim 2, further comprising:
based on disposing of the given operator, updating, by the one or more processors, a configuration map to eliminate references to the given operator.

5. The computer-implemented method of claim 1, wherein the continuously detecting comprises:
utilizing, by the one or more processors, a definition file to interpret a special flag in each custom resource to determine a version for each custom resource of the custom resources.

6. The computer-implemented method of claim 5, further comprising:
implementing, by the one or more processors, a field in the API, wherein based on the implementing, the API adds the field to the definition file, which implements the field and a value for the field in each custom resource of the custom resources, wherein the value for the field comprises the special flag.

7. The computer-implemented method of claim 1, wherein the continuously detecting is performed by an operator manager operating in an all-namespace mode.

8. The computer-implemented method of claim 1, wherein the automatically deploying comprises deploying the new operator to function in an all-namespace mode.

9. The computer-implemented method of claim 1, wherein the automatically deploying comprises:
obtaining, by the one or more processors, from a catalog source, artifacts associated with the software version of the given custom resource; and
utilizing, by the one or more processors, the artifacts to deploy the new operator.

10. The computer-implemented method of claim 1, wherein the operators comprise Kubernetes operators.

11. A computer system for facilitating operator management in a multiple tenant environment, the computer system comprising:
a memory; and
a node in communication with the memory, wherein the computer system is configured to perform a method, said method comprising:
continuously detecting software versions of custom resources and operators, wherein the software versions are associated with software provided as a service to the custom resources by an application programming interface (API) communicatively coupled to the operators;
based on the detecting, determining, for each custom resource, whether an operator in the multiple tenant environment is providing a software version of the custom resource; and
based on determining for a given custom resource of the custom resources that no operator in the multiple tenant environment is providing the software version of the given custom resource, automatically deploying, a new operator in a designated namespace, wherein the new operator provides the software version of the given custom resource to the given custom resource and the designated namespace is dedicated to the new operator.

12. The computer system of claim 11, further comprising:
based on the detecting, determining, for each operator, whether at least one custom resource of the custom resources is utilizing a software version of the operator; and
based on determining for a given operator that no custom resource operator in the multiple tenant environment is utilizing the software version provided by the given operator, disposing of the given operator.

13. The computer system of claim 11, further comprising:
based on the automatically deploying, updating a configuration map to map the given custom resource to the new operator.

14. The computer system of claim 12, further comprising:
based on disposing of the given operator, updating a configuration map to eliminate references to the given operator.

15. The computer system of claim 11, wherein the continuously detecting comprises:
utilizing a definition file to interpret a special flag in each custom resource to determine a version for each custom resource of the custom resources.

16. The computer system of claim 15, further comprising:
Implementing a field in the API, wherein based on the implementing, the API adds the field to the definition file, which implements the field and a value for the field in each custom resource of the custom resources, wherein the value for the field comprises the special flag.

17. The computer system of claim 11, wherein the continuously detecting is performed by an operator manager operating in an all-namespace mode.

18. The computer system of claim 11, wherein the automatically deploying comprises deploying the new operator to function in an all-namespace mode.

19. The computer system of claim 11, wherein the automatically deploying comprises:
obtaining, from a catalog source, artifacts associated with the software version of the given custom resource; and
utilizing the artifacts to deploy the new operator.

20. A computer program product for facilitating operator management in a multiple tenant environment, the computer program product comprising:
one or more computer readable storage media and program instructions collectively stored on the one or more computer readable storage media to perform a method comprising:
continuously detecting software versions of custom resources and operators, wherein the software versions are associated with software provided as a service to the custom resources by an application programming interface (API) communicatively coupled to the operators;
based on the detecting, determining, for each custom resource, whether an operator in the multiple tenant environment is providing a software version of the custom resource; and
based on determining for a given custom resource of the custom resources that no operator in the multiple tenant environment is providing the software version of the given custom resource, automatically deploying, a new operator in a designated namespace, wherein the new operator provides the software version of the given custom resource to the given custom resource and the designated namespace is dedicated to the new operator.
